(19) United States
(12) Patent Application Publication
(10) Pub. No.: US 2025/0245519 A1
(43) Pub. Date: Jul. 31, 2025

(54) INFORMED PRUNING FOR DEFENDING AGAINST MODEL INVERSION ATTACKS IN FEDERATED LEARNING

(71) Applicant: Dell Products L.P., Round Rock, TX (US)

(72) Inventors: Isabella Costa Maia, São Paulo (BR); Iam Palatnik de Sousa, Rio de Janeiro (BR); Maira Beatriz Hernandez Moran, Rio de Janeiro – RJ (BR); Paulo Abelha Ferreira, Rio de Janeiro – RJ (BR); Pablo Nascimento da Silva, Niterói – RJ (BR); Eduarda Tatiane Caetano Chagas, Belo Horizonte – MG (BR)

(21) Appl. No.: 18/422,676

(22) Filed: Jan. 25, 2024

(51) Int. Cl. G06N 3/098; G06F 21/55

(52) U.S. Cl. CPC G06N 3/098; G06F 21/554

(57) ABSTRACT

One example method includes generating a first loss gradient tensor by training a machine-learning (ML) model using a private data input. A second loss gradient tensor is generated by training the ML model using a randomized data input. The first and second loss gradient tensors are used in an iterative process to update the second loss gradient tensor, the iterative process being repeated until the randomized data input approximates the private data input. Index positions of gradient values that are greater than a p-th percentile are identified in the updated second loss gradient tensor. The gradient values that are greater than a p-th percentile are pruned from the first loss gradient tensor to thereby generate a third loss gradient tensor that does not include the gradient values that are greater than a p-th percentile.

### FIELD OF THE INVENTION

Embodiments of the present invention generally relate to federated learning processes. More particularly, at least some embodiments of the invention relate to systems, hardware, software, computer-readable media, and methods for a client node to defend against model inversion attacks in a federated learning system.

### BACKGROUND

Federated Learning (FL) consists of a distributed framework for Machine Learning in which a global model is trained jointly by several nodes without ever sharing their local data. FL is an essential area for companies interested in providing infrastructure for private distributed Machine Learning (e.g., massive deployment of ML models to the edge where data must be kept local due to compliance, cost, or strategic reasons).

FL implements strong privacy guarantees. However, it suffers from specific security issues not necessarily present in other Machine Learning scenarios. One of the most efficient privacy attacks is a model inversion attack. The main idea behind this type of attack is intercepting and then using a client nodes loss gradient tensors to help to identify private data that is associated with the loss gradient tensors.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1A discloses aspects of a Federated Learning (FL) setting;

FIG. 1B illustrates aspects of an embodiment of a model inversion attack on the FL setting of FIG. 1A;

FIG. 2 discloses aspects of a model inversion attack;

FIG. 3 discloses aspects of FL setting for defending against a model inversion attack;

FIG. 4 discloses aspects of experimental results of the embodiments disclosed herein defending against a model inversion attack;

FIG. 5 discloses aspects of experimental results of the embodiments disclosed herein defending against a model inversion attack;

FIG. 6 discloses aspects of experimental results of the embodiments disclosed herein defending against a model inversion attack;

FIG. 7 discloses a method according to an embodiment; and

FIG. 8 discloses an example computing entity configured to perform any of the disclosed methods, processes, and operations.

### DETAILED DESCRIPTION OF SOME EXAMPLE EMBODIMENTS

Embodiments of the present invention generally relate to federated learning processes. More particularly, at least some embodiments of the invention relate to systems, hardware, software, computer-readable media, and methods for a client node to defend against model inversion attacks in a federated learning system.

In general, example embodiments of the invention are directed towards detecting a client isolation attack at a client node. One example method includes generating a first loss gradient tensor by training a machine-learning (ML) model using a private data input. A second loss gradient tensor is generated by training the ML model using a randomized data input. The first and second loss gradient tensors are used in an iterative process to update the second loss gradient tensor, the iterative process being repeated until the randomized data input approximates the private data input. Index positions of gradient values that are greater than a p-th percentile are identified in the updated second loss gradient tensor. The gradient values that are greater than a p-th percentile are pruned from the first loss gradient tensor to thereby generate a third loss gradient tensor that does not include the gradient values that are greater than a p-th percentile.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at least some embodiments of the invention is that a way is provided for a client node in a Federated Learning setting to self-defend against a model inversion attack. In particular, the client node is able to perform a simulated model inversion attack and then remove the positions in a loss gradient tensor that are most likely to be comprised during the model version attack. Thus, the embodiments of the invention disclosed herein provide enhanced privacy and security as the client node is able to minimize model inversion attacks. This in turn ensures that the privacy of the data stored on the client node is maintained and better protected from malicious parties.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Overview

Federated Learning (FL) consists of a distributed framework for Machine-Learning (ML) in which a global model is trained jointly by several nodes without ever sharing their local data. FL is an essential area for companies interested in providing infrastructure for private distributed machine-learning (e.g., massive deployment of ML models to the edge where data must be kept local due to compliance, cost, or strategic reasons).

FL implements strong privacy guarantees. However, it suffers from specific security issues not necessarily present in other ML scenarios. For instance, it is known that the distributed nature, architectural design, and data constraints of federated learning open up new failure modes and attack surfaces. Several of these attacks aim to compromise the privacy of clients.

Standard FL settings are composed of client nodes, which are configured to perform local training using their own private datasets and maintain local models, and a server, which is configured to unify the local models in a unique global model based on client nodes' updates, in a step called aggregation. This process is performed iteratively for several rounds. Note that this approach ensures that the private data is not directly handled by the server as the client nodes only share model gradients and not the underlying datasets. Nevertheless, even the intermediate information shared in this aggregation process can be used in different attacks to reveal the client node's private data.

Client isolation is one of the most effective privacy attacks, especially when combined with other attacks. This kind of attack's basic premise is that inferring client-specific data from updates obtained after local training of an aggregated global model is highly challenging since the global model was updated using information from numerous clients, not just the target client. In other words, the local training performed might not be enough to obtain client data from the update. In this way, the client isolation attack seeks to increase the private data influence on updates of the target client node. In order to accomplish this, the client node is isolated, which prevents it from accessing the global model for several global rounds.

One such isolation attack is known as a model inversion attack. In a model inversion attack, a malicious party can perform, for instance, the isolation attack, to intercept communication and obtain a client node's model gradients. Once in possession of the model gradients, various adaptive methods can be employed to create data that generates similar gradient responses from the model. The resulting generated data closely resembles the private training data, and as such may breach privacy.

Currently, one of the main techniques employed to tackle data information leakage during a model inversion attack is gradient pruning. This method works by randomly selecting a percentage of the gradient updates lowest values and setting them to zero at the client node level, making it sparser and less informative about the original data. However, this technique can sometimes remove relevant information from the model gradient, entailing a poorer model convergence (higher training loss).

### B. Context

In general, some embodiments are directed to resolving one or more challenge posed by model inversion attacks in Federated Learning (FL). Following is contextual information for some example embodiments.

### B.1 Federated Learning

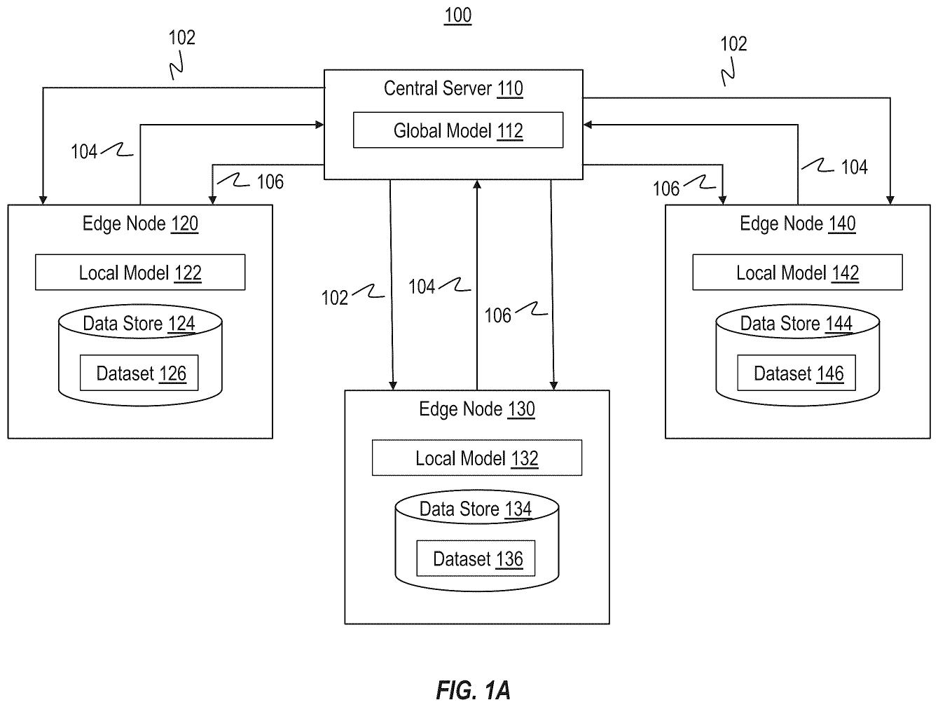

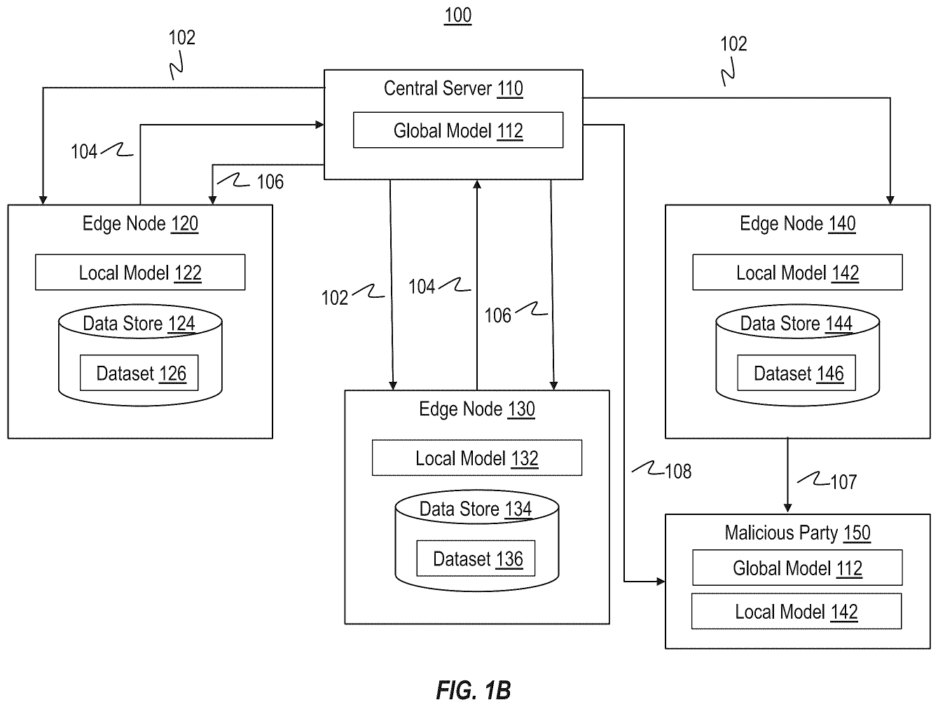

As shown in FIG. 1A, in a normal FL setting 100, a central server 110 provides an initial global model 112 to a client node 120, a client node 130, and a client node 140 as shown at 102. The client node 120 includes a local model 122 and a local data store 124 that stores a local dataset 126. The client node 130 includes a local model 132 and a local data store 134 that stores a local dataset 136. The client node 140 includes a local model 142 and a local store 144 that stores a local dataset 146. The global model 112 and the local models 122, 132, and 142 may be any reasonable ML model such as, but not limited to, deep neural networks, convolutional neural networks, multilayer neural networks, recursive neural networks, logistic regressions, isolation forests, k-nearest neighbors, support vector machines (SVM), or any other reasonable machine-learning model. It will be understood that the local models are local versions of the global model that is provided to the client nodes by the central server during an initial cycle.

The client node 120 performs local training on the local model 122 using the local dataset 126. Likewise, the client node 130 performs local training on the local model 132 using the local dataset 136. In a similar manner, the client node 140 performs local training on the local model 142 using the local dataset 146.

As a result of the local training, the local models 122, 132, and 142 are updated to fit the local datasets 126, 136, and 146 respectively to the global model 112. As shown at 104, the updated local models 122, 132, and 142 are sent by the client nodes to the central server 110, which aggregates the updates of all client nodes to obtain an updated global model 112. This new updated global model 112 is then sent back to the client nodes 120, 130, and 140 as shown at 106 and become the local models 122, 132, and 142. This cycle is repeated iteratively for a user determined amount of update rounds. It will be noted that after each cycle, each of the client nodes have a local model (i.e., local models 122, 132, and 142) that not only fits each client nodes local datasets (i.e., local datasets 126, 136, and 146), but that also fits the local datasets of the other client nodes, resulting in a local model with a good generalization. It will be appreciated that when sending the updated local models to the central server 110, each client node is actually sending model gradient data that is the result of training the local models using the local datasets. It is the model gradient data that is then used to update the global model 112. In this way, the local datasets are not sent to the central server 110 to thereby preserve privacy of the local datasets.

### B.2 Model Inversion Attacks in Federated Learning

FIG. 1B shows an isolation attack on the FL setting 100 of FIG. 1A, which is often done in conjunction with a model inversion attack. In FIG. 1B, the central server 110 provides the initial global model 112 to the client node 120, the client node 130, and the client node 140 as shown at 102 in the manner previously described in relation to FIG. 1A. However, as shown in FIG. 1B, a malicious party 150 intercepts the process flow between the central server 110 and the client node 140 and is thus able to receive local model updates that were intended for the central server 110 Thus, after the client node 140 has performed the local training on the local model 142 using the local dataset 146, the client node 140 sends, as shown at 107, the updated local model 142, which is the model gradient data resulting from training the local model 142 using the dataset 146, to the malicious party 150 instead of the central server 110. In addition, during the isolation attack the malicious party 150 is able to obtain the global model 112 from the central server as shown at 108 and/or obtain the local model 142 for use during the model inversion attack as will be explained in more detail to follow.

A model inversion attack as will now be explained in relation to a Gradient Similarity attack, which is one of the main known model inversion attacks. The Gradient Similarity model inversion attack minimizes a cosine similarity cost function according to Equation 1 using an Adam optimizer:

$$arg {min}_{x ∈ {[ 0 , 1 ]}^{n}} 1 - \frac{〈 {∇}_{θ} {ℒ}_{θ} ( x , y ) , {∇}_{θ} {ℒ}_{θ} ( {x}^{*} , y ) 〉}{‖ {∇}_{θ} {ℒ}_{θ} ( x , y ) ‖ ‖ {∇}_{θ} {ℒ}_{θ} ( {x}^{*} , y ) ‖} + α TV ( x ) \qquad Equation 1$$

where, θ are the network parameters, x is a reconstruction image, x* is an input image, y is an image label, ∇_{θ} [symbol] _{θ}(x, y) is the loss gradient of the reconstructed image and image label w.r.t. model weights, ∇_{θ} [symbol] _{θ}(x*, y) is the loss gradient of the input image and image label w.r.t. model weights, and α TV(x) is the total variation function of the reconstruction image.

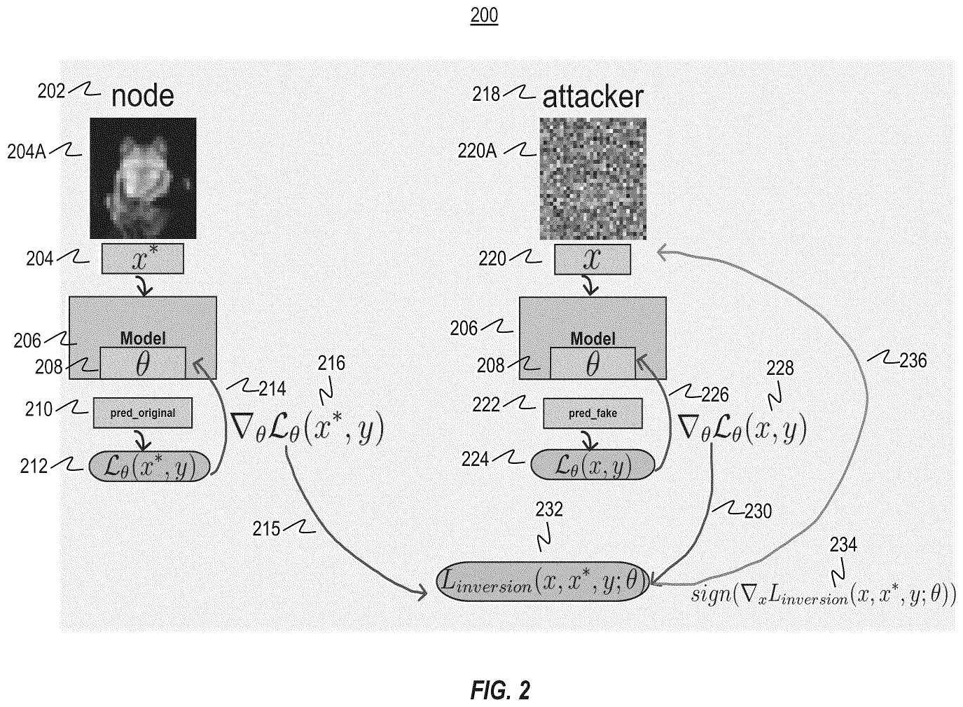

FIG. 2 illustrates an embodiment 200 of a Gradient Similarity model inversion attack. As illustrated, FIG. 2 includes a client node 202, which may correspond to the client node 140. The client node 202 includes an input image 204 (x*), which in the embodiment is shown to be a frog 204A and which may correspond to the local dataset 146. The client node 202 includes a machine-learning (ML) model 206, which may correspond to the local model 142, and which includes model parameters 208 (θ).

During training, the ML model 206 inputs the input image 204 and makes predications 210 regarding the input. The model generates gradients 212 regarding the predictions, which in the embodiment is the gradient tensor [symbol] _{θ}(x*, y). This process may be repeated during a number of iterations 214 until a final loss gradient tensor 216 is found, which in the embodiment is ∇_{θ} [symbol] _{θ}(x*, y).

FIG. 2 also includes an attacking computing system that is referred to as attacker 218, which may correspond to the malicious party 150. In the embodiment, the attacker 218 has intercepted the process flow between the client node 202 and a central server such as the central server 110 and has also obtained the global and/or local models. Thus, as shown at 215, the client node 202 sends the final loss gradient tensor 216 to the attacker 218, which will be used as part of the Gradient Similarity model inversion attack.

As part of the model inversion attack, the attacker 218 starts with a random initialization input or reconstruction image 220 (x), which in the embodiment is shown to be a random collection of pixels 220A that do not show any recognizable image. The attacker 218 includes the ML model 206, which includes model parameters 208 (θ). As mentioned previously, the ML model the attacker uses will be the same ML model as the client node 202 because the attacker has obtained the global and/or local ML models.

During training, the ML model 206 inputs the random initialization input or reconstruction image 220 and makes predications 222 regarding the input. The ML model generates gradients 224 regarding the predictions, which in the embodiment is the gradient tensor [symbol] _{θ}(x, y). This process may be repeated during a number of iterations 226 until a final loss gradient tensor 228 is found, which in the embodiment is ∇_{θ} [symbol] _{θ}(x, y). The process of obtaining the final loss gradient tensor 228 may occur prior to intercepting the process flow between the client node 202 and the central server, while intercepting the process flow between the client node 202 and the central server, or after intercepting the process flow between the client node 202 and the central server.

Once the attacker has the final loss gradient tensor 216 from the client node 202 and the its own final loss gradient tensor 228, these gradient tensors are used as shown at 215 and 230 to calculate an inversion loss 232, which in the embodiment is Lᵢₙᵥₑᵣₛᵢₒₙ(x, x*, y; θ) associated with Equation 1. An inversion gradient with respect to the reconstruction image 234, which in the embodiment is ∇ₓLᵢₙᵥₑᵣₛᵢₒₙ(x, x*, y; θ), is calculated and backwardly propagated to update the random initialization input or reconstruction image 220 (x). This process may be repeated by a number of iterations 236 until the random initialization input or reconstruction image 220 (x) reveals information about the input image 204 (x*). In other words, the iterations 236 are repeated as many times as needed until the random initialization input or reconstruction image 220 (x) approximates the input image 204 (x*) closely enough that the attacker 218 can determine the underlying data of the input image 204 (x*), which in the embodiment would result in the random initialization input or reconstruction image 220 (x) showing an image that approximated the frog 204A. In one embodiment, the number of iterations 236 needed for the random initialization input or reconstruction image 220 (x) to approximate the input image 204 (x*) is around nᵢₜₑᵣₐₜᵢₒₙₛ=2000.

### C. Aspects of Some Example Embodiments

The embodiments disclosed herein are directed to a novel automatic pruning method for determining the positions to be pruned out in the loss gradient tensor at each participant node in a federation, for each FL training cycle. This technique allows for achieving higher data privacy scores at a lower ML model performance cost when compared to traditional techniques against ML model inversion attacks such as random gradient pruning or gradient compression.

In the embodiments, previously to sharing its gradient updates with the federation's central server, each client node “attacks” its own training gradient tensor by performing the so-called Gradient Similarity (GS) optimization. By doing so, for each local ML model update, a client node obtains an “attack” gradient capable of approximating random noise to its own private data. The embodiments show that, by performing a reasonable number of inversion iterations, one can obtain this “attack” gradient such that it reveals information about the most privacy-breaching-sensitive positions of the training gradient tensor. These positions are then utilized by the node to prune out its own training gradient before sending it to the federation's central server. The embodiments are compared to other ML model inverse defense baselines and to show that the embodiments not only induces more privacy as it also does it at a lower ML model performance cost.

The embodiments disclosed herein include, but are not limited to, the following innovations: (1) A novel defense method against model inversion, where each node finds the gradient updates positions to be pruned out specifically informed by their privacy-breaching capacity under such attack. (2) This novel pruning method provides better data privacy under model inversion attacks when compared to other baseline defense methods such as random pruning and gradient compression. (3) The described solution is also able to provide better model convergence results while keeping a higher privacy score when compared to the tested baseline approaches

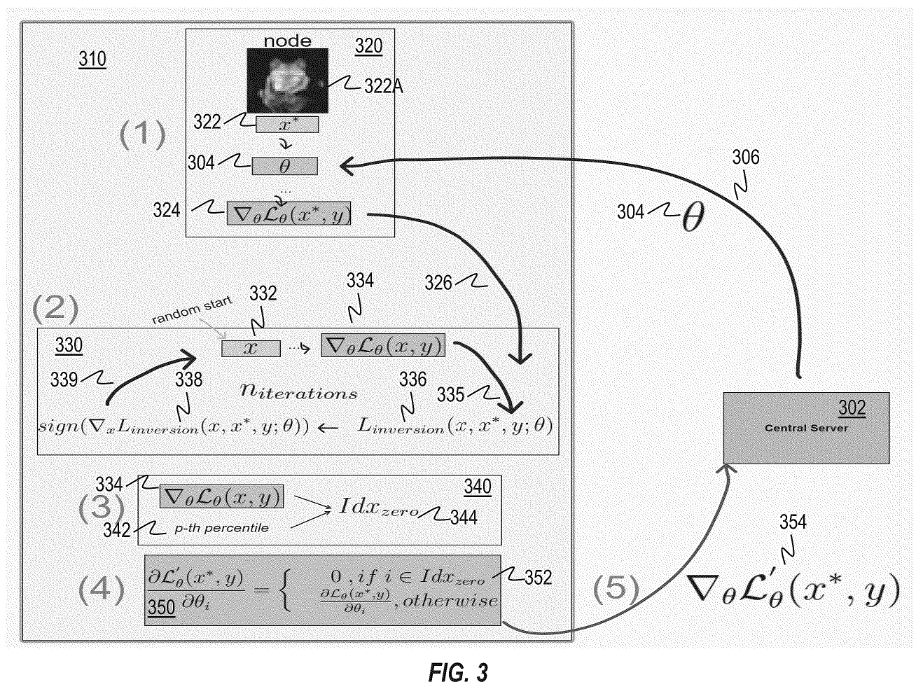

FIG. 3 illustrates an embodiment of a FL setting 300 that is able to perform the embodiments disclosed herein. As illustrated, the FL setting 300 includes a central server 302 which may correspond to the central server 110 previously described. The FL setting 300 also includes a client node 310, which may correspond to one of the client nodes 120, 130, or 140 previously described. In operation, the central server 302 provides a ML model 304, illustrated in the embodiment as θ, to the client node 310 as shown at 306.

The client node 310 includes a local training module 320. In operation, the local training module 320 performs a step (1) of training the ML model 304 (θ), using the process performed by the client node 202 previously described in relation to FIG. 2. For example, the training module 320 inputs an input image 322 (x*), which in the embodiment is shown to be a frog 322A and which may correspond to a local data input that is meant to be private to the client node 310, to the ML model 304 (θ). During training, the ML model 304 (θ) makes predications regarding the input image 322 (x*). The ML model 304 (θ) generates gradients regarding the predictions, which in the embodiment is the loss gradient tensor [symbol] _{θ}(x*, y). This process may be repeated during a number of iterations until a final loss gradient tensor 324 is found, which in the embodiment is ∇_{θ} [symbol] _{θ}(x*, y).

The client node 310 includes a local inversion module 330. In operation, the local inversion module 330 performs a step (2) of simulating a model inversion attack, such as a Gradient Similarity model inversion attack, using the same process as the model inversion attack performed by the attacker 218 discussed previously. For example, as part of the simulated model inversion attack, the local inversion module 330 starts with a random initialization input or reconstruction image 332 (x). Although not shown, the local inversion module 330 uses the ML model 304 (θ) when performing the simulated model inversion attack.

During the simulated model inversion attack, the random initialization input or reconstruction image 332 (x) is input into the ML model 304 (θ), which makes predications regarding the input. The ML model 304 (θ) generates gradients regarding the predictions, which in the embodiment is the loss gradient tensor [symbol] _{θ}(x, y). This process may be repeated during a number of iterations until a final loss gradient tensor 334 is found, which in the embodiment is ∇_{θ} [symbol] _{θ}(x, y).

Once the local inversion module 330 receives the final loss gradient tensor 324 from the local training module 320 and has obtained its own final loss gradient tensor 334, these gradient tensors are used as shown at 326 and 335 to calculate an inversion loss 336, which in the embodiment is Lᵢₙᵥₑᵣₛᵢₒₙ(x, x*, y; θ) associated with Equation 1. An inversion gradient with respect to the reconstruction image 338, which in the embodiment is ∇ₓLᵢₙᵥₑᵣₛᵢₒₙ(x, x*, y; θ), is calculated and backwardly propagated to update the random initialization input or reconstruction image 332 (x). This process may be repeated by a number of iterations 339 until the random initialization input or reconstruction image 332 (x) reveals information about the original input image 322 (x*). In other words, the iterations 339 are repeated as many times as needed until the random initialization input or reconstruction image 332 (x) approximates the original input image 332 (x*) closely enough to determine the underlying data of the original input image 332 (x*), which in the embodiment would result in the random initialization input or reconstruction image 332 (x) showing an image that approximated the frog 322A. As will be explained in more detail to in the Experiments section to follow, the number of iterations 339 needed for the random initialization input or reconstruction image 332 (x) to approximate the original input image 332 (x*) is much less than the number needed by the attacker 218. Thus, even if the reconstruction image does not display sensitive information, a few iterations are enough to provide a reconstruction loss gradient tensor that is informative about its position's importance to model inversion.

The client node 310 includes a position index module 340. In operation, the position index module 340 performs a step (3) that obtains the tensor position indexes of the final (i.e., after the iterations 339 have been completed) loss gradient tensor 334 ∇_{θ} [symbol] _{θ}(x, y) where gradient values are greater than a given p-th percentile 342. Those gradient values that are greater than the p-th percentile 342 are the gradient values having the largest privacy-breaching capacity if a model inversion attack is successfully conducted against the final loss gradient tensor 334 ∇_{θ} [symbol] _{θ}(x, y).

For example, let the ML model network be composed of K parameters such that |θ|=K.

$${∇}_{θ} {ℒ}_{θ} ( x , y ) = [ \begin{matrix}\frac{\partial {ℒ}_{θ} ( x , y )}{\partial {θ}_{1}} & & … \\ & ⋱ & \\ … & & \frac{\partial {ℒ}_{θ} ( x , y )}{\partial {θ}_{K}}\end{matrix} ]$$

Given a p-th percentile

$$t = \frac{\partial {ℒ}_{θ} ( x , y )}{\partial {θ}_{i}} ,$$

i∈1, . . . , K, the position index module 340 selects the set of tensor position indexes Idx_{zero} 344 that contains the tensor positions corresponding to the top (100−p) % values of the reconstruction loss gradient, i.e.

$${Idx}_{zero} = \{ i ∈ \{ 1 , … , K \} \backslash \frac{\partial {ℒ}_{θ} ( x , y )}{\partial {θ}_{i}} \geq t \} .$$

Thus, the set of tensor position indexes Idx_{zero} 344 contains the tensor positions of those gradient values having the largest privacy-breaching capacity if a model inversion attack is successfully conducted against the final loss gradient tensor 334 ∇_{θ} [symbol] _{θ}(x, y).

In one embodiment, the p-th percentile 342 was selected as 90-th percentile. This value was selected, because as discussed in the experiment results section to follow, the 90-th percentile was verified that it can induce both better privacy/lower reconstruction values and better ML model convergence when compared to conventional pruning methods. However, the embodiments disclosed herein are not limited to a 90-th percentile. In other embodiments other p-th percentiles 342 can be selected based on the configuration, data, and training parameters of the federation where the embodiments are being implemented. In some embodiments, the selected p-th percentile 342 is then experimentally validated to ensure that performance of the embodiments disclosed herein is satisfactory. Thus, the claims and embodiments disclosed herein are not limited to a particular p-th percentile 342 as the p-th percentile 342 is selectable based on operating scenario of the federation.

The client node 310 includes a pruning module 350. In operation, the pruning module 350 performs a step (4) of pruning out the gradient values that are included in the set of tensor position indexes Idx_{zero} 344 from the final loss gradient tensor 324 ∇_{θ} [symbol] _{θ}(x*, y). In one embodiment, as shown at 352 the pruning module 350 performs the pruning step (4) according to the following equation:

$$\frac{\partial {ℒ}_{θ}^{′} ( {x}^{*} , y )}{\partial {θ}_{i}} = \{ \begin{matrix}0 , if i ∈ {Idx}_{zero} \\ \frac{\partial {ℒ}_{θ} ( {x}^{*} , y )}{\partial {θ}_{i}} , otherwise\end{matrix}$$

Performing the pruning step (4) results in the generation of a new loss gradient tensor 354, which in the embodiment is ∇_{θ} [symbol] (x*, y), where the gradient values that are included in the set of tensor position indexes Idx_{zero} 344 have been zeroed out or in other words removed from the new loss gradient tensor 354 ∇_{θ} [symbol] (x*, y). Advantageously, the gradient values that are selected to be removed from the new loss gradient tensor 354 ∇_{θ} [symbol] (x*, y) are not just randomly selected as is done in some conventional systems, but they are selected based on their increased privacy-breaching capacity. Thus, the selection and pruning operations are informed operations.

In operation, the client node 310 is then able to perform a step (5) of sharing the new loss gradient tensor 354 ∇_{θ} [symbol] (x*, y) with the central server 302. The central server 302 can then use the new loss gradient tensor 354 ∇_{θ} [symbol] (x*, y) to update the global ML model, which can in turn be provided to the client node 310 and the other nodes of the federation. Advantageously, however, if the new loss gradient tensor 354 ∇_{θ} [symbol] (x*, y) is intercepted by a malicious party 150 such as the attacker 218, the removal of the gradient values that are included in the set of tensor position indexes Idx_{zero} 344 will make is much less likely that the malicious party is able to obtain any private data from the new loss gradient tensor 354 ∇_{θ} [symbol] (x*, y).

### D. Experiments and Results

The process of the current invention described in relation to FIG. 3 was evaluated using a federated learning simulator using the following configuration:
10 nodes in the federation
100 FL training cycles
nᵢₜₑᵣₐₜᵢₒₙₛ=100 (client nodes protecting the gradient locally, before sending it to the central server)
p=90 (90-th percentile)

The results for the current invention were compared with random pruning and gradient compression baselines. The names used in the experiment represent the following:
mi90: model-inversion-informed pruning (current invention) with 90-th percentile
rdn70: random pruning with 70% of gradient values left
fg: full gradient (no pruning is applied)
low70: gradient compression with 70% of greatest gradient values left

As the ultimate goal of the current invention is to provide protection against model inversion attacks, the success a malicious party 150 would have when performing the procedure discussed previously in FIG. 2 for nᵢₜₑᵣₐₜᵢₒₙₛ=2000 (e.g., attacker 218 tampering with the final loss gradient tensor 216 sent by the client node 202) was quantified. For that, two reconstruction metrics, Peak Signal-to-Noise Ratio (PSNR) 402, measured in logarithmic scale, and Structural Similarity Index (SSIM) 404, were used.

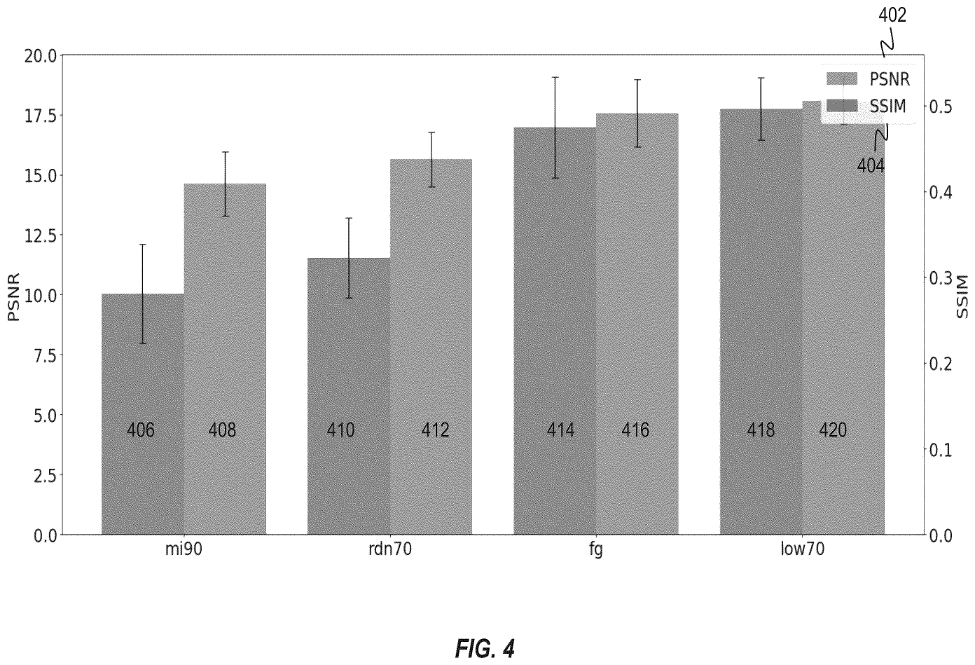

FIG. 4 shows a plot 400 that shows the two reconstruction metrics averaged over 6 out of 10 federation's nodes with an attacker intercepting each of their loss gradients at FL training cycles={1, 6, 21, 51, 100}. Thus, the plot 400 shows each reconstruction metric's average and standard deviation for each of mi90, rdn70, fg, and low70. As shown in FIG. 4, mi90, the current invention, has an SSIM average 406 and a PSNR average 408, rdn70 has an SSIM average 410 and a PSNR average 412, fg has an SSIM average 414 and a PSNR average 416, and low70 has an SSIM average 418 and a PSNR average 420.

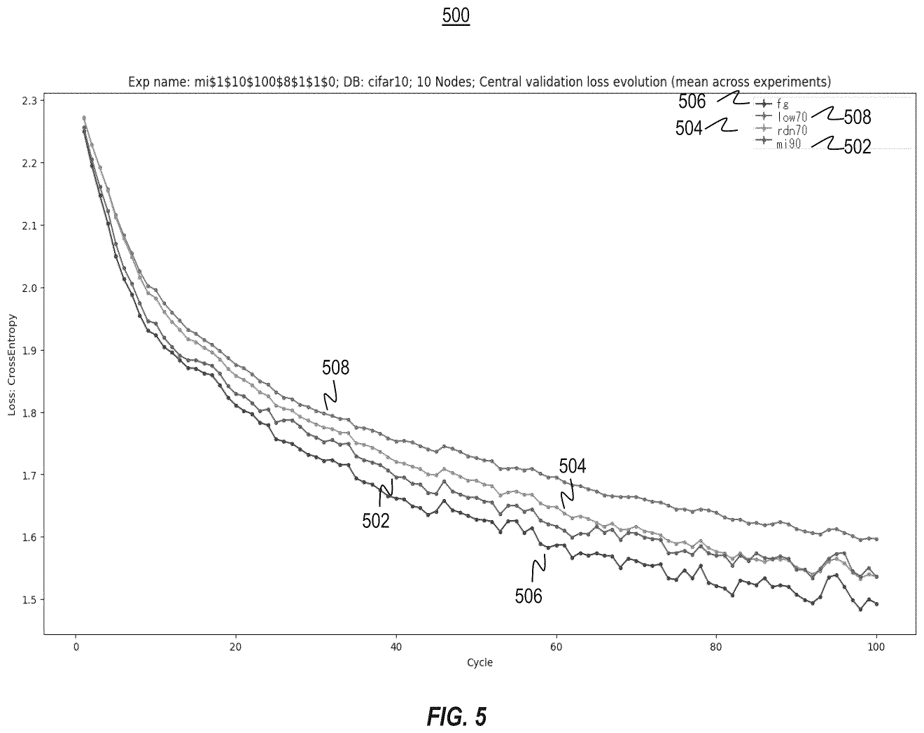

FIG. 5 shows a plot 500 of CrossEntropy loss for each of mi90, rdn70, fg, and low70 across the FL training cycles as monitored at the central server. As shown in the plot 500, mi90, the current invention, has a CrossEntropy loss shown at 502, rdn70 has a CrossEntropy loss shown at 504, fg has a CrossEntropy loss shown at 506, and low70 has a CrossEntropy loss shown at 508.

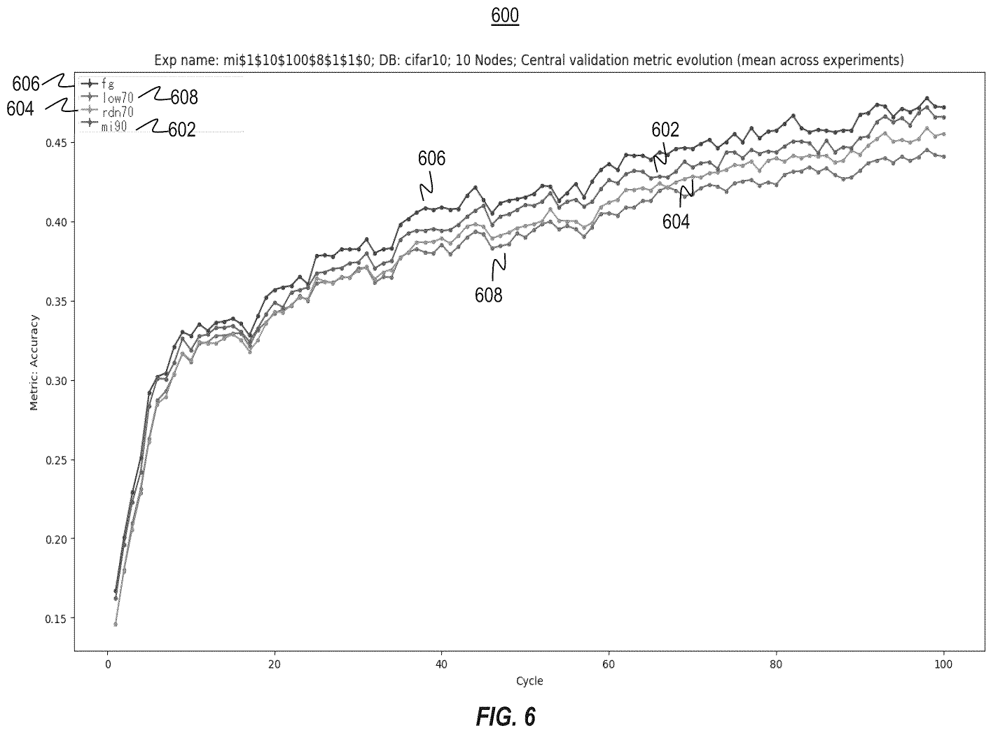

FIG. 6 shows a plot 600 of accuracy for each of mi90, rdn70, fg, and low70 across the FL training cycles as monitored at the central server. As shown in the plot 600, mi90, the current invention, has an accuracy shown at 602, has an accuracy shown at 602, fg has an accuracy shown at 606, and low70 has an accuracy shown at 608.

As shown in FIG. 4, mi90 reaches the lowest average reconstruction values, meaning a lower privacy breach risk under a model inversion attack. Moreover, it is seen in FIG. 5 that mi90 incurs, for most FL training cycles, a better central model convergence than rdn70 and in a considerably lower loss than that induced by low70. These results are consistent with those observed in FIG. 6, where mi90 causes the central model to achieve higher accuracy than the conventional baseline pruning approaches. Thus, the current invention is able to provide more data privacy security while keeping a better ML model performance than the tested conventional baseline approaches.

It could be argued that it would be too computationally demanding to perform a local model inversion before sharing the loss gradient at each training cycle iteration as is done in the current invention. However, even if the current invention indeed requires more computation than the tested conventional baselines, the experiments show that by performing 5% of the number of iterations an attacker would typically need to breach a user's privacy, a node can already achieve higher privacy than it would with the conventional baselines. Thus, the current invention is pertinent for cases where data information is highly sensitive, and it could be chosen to be applied in specific batches that require increased security.

### D. Example Methods

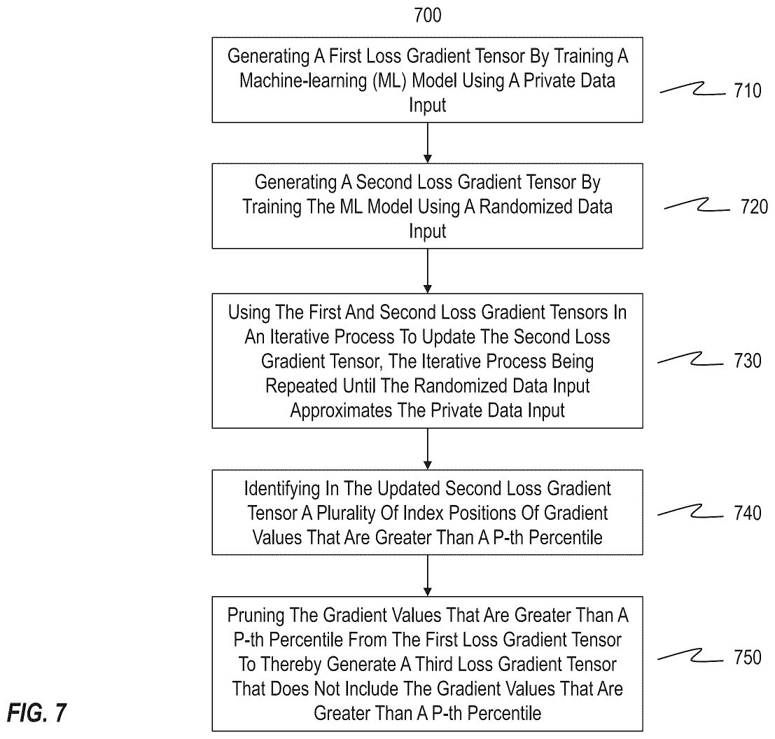

It is noted with respect to the disclosed methods, including the example method 700 of FIG. 7, that any operations of any of these methods, may be performed in response to, as a result of, and/or, based upon, the performance of any preceding operations. Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 7, an example method 700 is disclosed. The method 700 will be described in relation to one or more of the figures previously described, although the method 700 is not limited to any particular embodiment.

The method 700 includes generating a first loss gradient tensor by training a machine-learning (ML) model using a private data input (710). For example, as previously described the local training module 320 inputs the input image 322 (x*) to the ML model 304 (θ). The leads to the generation of the final loss gradient tensor 324 ∇_{θ} [symbol] _{θ}(x*, y).

The method 700 includes generating a second loss gradient tensor by training the ML model using a randomized data input (720). For example, as previously described the local inversion module 330 inputs the random initialization input or reconstruction image 332 (x) to the ML model 304 (θ). The leads to the generation of the final loss gradient tensor 334 ∇_{θ} [symbol] _{θ}(x, y).

The method 700 includes using the first and second loss gradient tensors in an iterative process to update the second loss gradient tensor, the iterative process being repeated until the randomized data input approximates the private data input (730). For example, as previously described the local inversion module 330 uses the final loss gradient tensor 324 ∇_{θ} [symbol] _{θ}(x*, y) and the final loss gradient tensor 334 ∇_{θ} [symbol] _{θ}(x, y) in an iterative process 339 that updates the final loss gradient tensor 334 ∇_{θ} [symbol] _{θ}(x, y). This process continues until the random initialization input or reconstruction image 332 (x) approximates the input image 322 (x*).

The method 700 includes identifying in the updated second loss gradient tensor a plurality of index positions of gradient values that are greater than a p-th percentile (740). For example, as previously described the position index module 340 identifies the set of tensor position indexes Idx_{zero} 344 of the loss gradient tensor 334 ∇_{θ} [symbol] _{θ}(x, y) where gradient values are greater than a given p-th percentile 342. As previously discussed, in some embodiments the p-th percentile 342 is the 90-th percentile.

The method 700 includes pruning the gradient values that are greater than a p-th percentile from the first loss gradient tensor to thereby generate a third loss gradient tensor that does not include the gradient values that are greater than a p-th percentile (750). For example, as previously described the pruning module 350 prunes out the gradient values that are included in the set of tensor position indexes Idx_{zero} 344 from the final loss gradient tensor 324 ∇_{θ} [symbol] _{θ}(x*, y). This results in the generation of the new loss gradient tensor 354 ∇_{θ} [symbol] (x*, y), where the gradient values that are included in the set of tensor position indexes Idx_{zero} 344 have been zeroed out or in other words removed from the new loss gradient tensor 354 ∇_{θ} [symbol] (x*, y).

### E. Further Example Embodiments

Following are some further example embodiments of the invention. These are presented only by way of example and are not intended to limit the scope of the invention in any way.

Embodiment 1. A method performed at a client node of a federated learning system, the method comprising: generating a first loss gradient tensor by training a machine-learning (ML) model using a private data input; generating a second loss gradient tensor by training the ML model using a randomized data input; using the first and second loss gradient tensors in an iterative process to update the second loss gradient tensor, the iterative process being repeated until the randomized data input approximates the private data input; identifying in the updated second loss gradient tensor a plurality of index positions of gradient values that are greater than a p-th percentile; and pruning the gradient values that are greater than a p-th percentile from the first loss gradient tensor to thereby generate a third loss gradient tensor that does not include the gradient values that are greater than a p-th percentile.

Embodiment 2. The method as recited in embodiment 1, further comprising: providing the third loss gradient tensor from the client node to a central server of the federated learning system.

Embodiment 3. The method as recited in any of embodiments 1-2, wherein the p-th percentile is a 90-th percentile.

Embodiment 4. The method as recited in any of embodiments 1-3, wherein the gradient values that are greater than the p-th percentile are gradient values having a high privacy-breaching capacity when a model inversion attack is successfully conducted.

Embodiment 5. The method as recited in any of embodiments 1-4, wherein the p-th percentile is selected based on a configuration, data, and training parameters of the federation learning system and then experimentally validated.

Embodiment 6. The method as recited in any of embodiments 1-5, wherein using the first and second loss gradient tensors in the iterative process to update the second loss gradient tensor comprises calculating an inversion loss.

Embodiment 7. The method as recited in the embodiment of 6, wherein the inversion loss is found by the following equation:

$$arg {min}_{x ∈ {[ 0 , 1 ]}^{n}} 1 - \frac{〈 {∇}_{θ} {ℒ}_{θ} ( x , y ) , {∇}_{θ} {ℒ}_{θ} ( {x}^{*} , y ) 〉}{‖ {∇}_{θ} {ℒ}_{θ} ( x , y ) ‖ ‖ {∇}_{θ} {ℒ}_{θ} ( {x}^{*} , y ) ‖} + α TV ( x )$$

where, θ are network parameters, x is a reconstruction image, x* is an input image, y is an image label, ∇_{θ} [symbol] _{θ}(x, y) is a loss gradient of the reconstructed image and image label w.r.t. model weights, ∇_{θ} [symbol] _{θ}(x*, y) is a loss gradient of the input image and image label w.r.t. model weights, and α TV(x) is a total variation function of the reconstruction image.

Embodiment 8. The method as recited in any of embodiments 1-7, wherein pruning the gradient values that are greater than a p-th percentile from the first loss gradient tensor comprises zeroing out the index positions of gradient values that are greater than a p-th percentile.

Embodiment 9. The method as recited in any of embodiments 1-8, wherein the method results in a Peak Signal-to-Noise Ratio (PSNR) and a Structural Similarity Index (SSIM) that are less than a PSNR and SSIM resulting from a random pruning operation and a gradient compression operation.

Embodiment 10. The method as recited in any of embodiments 1-9, wherein the method results in a lower loss and a higher accuracy than a loss or accuracy resulting from a random pruning operation and a gradient compression operation.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

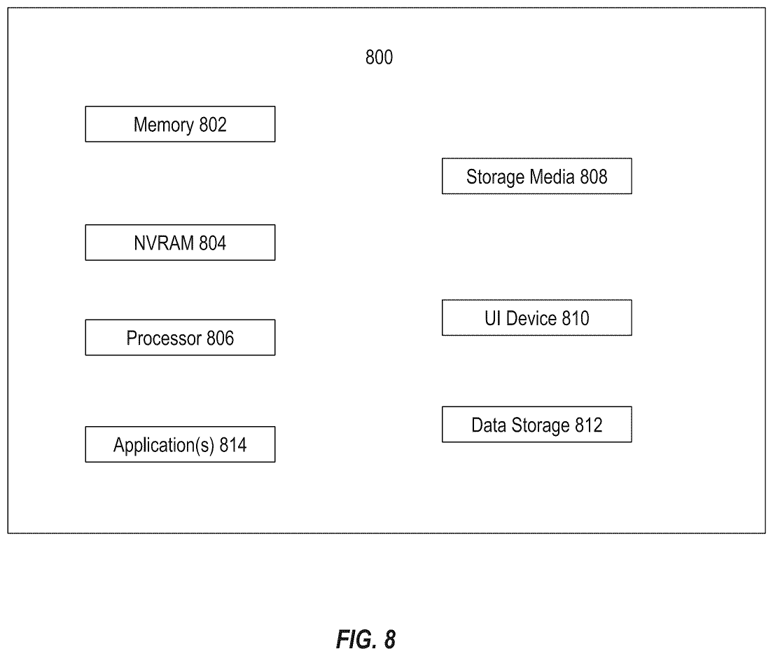

With reference briefly now to FIG. 8, any one or more of the entities disclosed, or implied, by FIGS. 1A-7, and/or elsewhere herein, may take the form of, or include, or be implemented on, or hosted by, a physical computing device, one example of which is denoted at 800. As well, where any of the aforementioned elements comprise or consist of a virtual machine (VM), that VM may constitute a virtualization of any combination of the physical components disclosed in FIG. 8.

In the example of FIG. 8, the physical computing device 800 includes a memory 802 which may include one, some, or all, of random access memory (RAM), non-volatile memory (NVM) 804 such as NVRAM for example, read-only memory (ROM), and persistent memory, one or more hardware processors 806, non-transitory storage media 808, UI device 810, and data storage 812. One or more of the memory components 802 of the physical computing device 800 may take the form of solid state device (SSD) storage. As well, one or more applications 814 may be provided that comprise instructions executable by one or more hardware processors 806 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method performed at a client node of a federated learning system, the method comprising:
generating a first loss gradient tensor by training a machine-learning (ML) model using a private data input;
generating a second loss gradient tensor by training the ML model using a randomized data input;
using the first and second loss gradient tensors in an iterative process to update the second loss gradient tensor, the iterative process being repeated until the randomized data input approximates the private data input;
identifying in the updated second loss gradient tensor a plurality of index positions of gradient values that are greater than a p-th percentile; and
pruning the gradient values that are greater than a p-th percentile from the first loss gradient tensor to thereby generate a third loss gradient tensor that does not include the gradient values that are greater than a p-th percentile.

2. The method of claim 1, further comprising:
providing the third loss gradient tensor from the client node to a central server of the federated learning system.

3. The method of claim 1, wherein the p-th percentile is a 90-th percentile.

4. The method of claim 1, wherein the gradient values that are greater than the p-th percentile are gradient values having a high privacy-breaching capacity when a model inversion attack is successfully conducted.

5. The method of claim 1, wherein the p-th percentile is selected based on a configuration, data, and training parameters of the federation learning system and then experimentally validated.

6. The method of claim 1, wherein using the first and second loss gradient tensors in the iterative process to update the second loss gradient tensor comprises calculating an inversion loss.

7. The method of claim 6, wherein the inversion loss is found by a following equation:
$$arg {min}_{x ∈ {[ 0 , 1 ]}^{n}} 1 - \frac{〈 {∇}_{θ} {ℒ}_{θ} ( x , y ) , {∇}_{θ} {ℒ}_{θ} ( {x}^{*} , y ) 〉}{‖ {∇}_{θ} {ℒ}_{θ} ( x , y ) ‖ ‖ {∇}_{θ} {ℒ}_{θ} ( {x}^{*} , y ) ‖} + α TV ( x )$$
where, θ are network parameters, x is a reconstruction image, x* is an input image, y is an image label, ∇_{θ} [symbol] _{θ}(x, y) is a loss gradient of the reconstruction image and image label w.r.t. model weights, ∇_{θ} [symbol] _{θ}(x*, y) is a loss gradient of the input image and image label w.r.t. model weights, and α TV(x) is a total variation function of the reconstruction image.

8. The method of claim 1, wherein pruning the gradient values that are greater than a p-th percentile from the first loss gradient tensor comprises zeroing out the index positions of gradient values that are greater than a p-th percentile.

9. The method of claim 1, wherein the method results in a Peak Signal-to-Noise Ratio (PSNR) and a Structural Similarity Index (SSIM) that are less than a PSNR and SSIM resulting from a random pruning operation and a gradient compression operation.

10. The method of claim 1, wherein the method results in a lower loss and a higher accuracy than a loss or accuracy resulting from a random pruning operation and a gradient compression operation.

11. A non-transitory storage medium having stored therein instructions that are executable by one or more hardware processors to perform operations comprising:
generating a first loss gradient tensor by training a machine-learning (ML) model using a private data input;
generating a second loss gradient tensor by training the ML model using a randomized data input;
using the first and second loss gradient tensors in an iterative process to update the second loss gradient tensor, the iterative process being repeated until the randomized data input approximates the private data input;
identifying in the updated second loss gradient tensor a plurality of index positions of gradient values that are greater than a p-th percentile; and
pruning the gradient values that are greater than a p-th percentile from the first loss gradient tensor to thereby generate a third loss gradient tensor that does not include the gradient values that are greater than a p-th percentile.

12. The non-transitory storage medium of claim 11, further comprising:
providing the third loss gradient tensor from a client node to a central server of a federated learning system.

13. The non-transitory storage medium of claim 11, wherein the p-th percentile is a 90-th percentile.

14. The non-transitory storage medium of claim 11, wherein the gradient values that are greater than the p-th percentile are gradient values having a high privacy-breaching capacity when a model inversion attack is successfully conducted.

15. The non-transitory storage medium of claim 11, wherein the p-th percentile is selected based on a configuration, data, and training parameters of a federation learning system and then experimentally validated.

16. The non-transitory storage medium of claim 11, wherein using the first and second loss gradient tensors in the iterative process to update the second loss gradient tensor comprises calculating an inversion loss.

17. The non-transitory storage medium of claim 16, wherein the inversion loss is found by a following equation:
$$arg {min}_{x ∈ {[ 0 , 1 ]}^{n}} 1 - \frac{〈 {∇}_{θ} {ℒ}_{θ} ( x , y ) , {∇}_{θ} {ℒ}_{θ} ( {x}^{*} , y ) 〉}{‖ {∇}_{θ} {ℒ}_{θ} ( x , y ) ‖ ‖ {∇}_{θ} {ℒ}_{θ} ( {x}^{*} , y ) ‖} + α TV ( x )$$
where, θ are network parameters, x is a reconstruction image, x* is an input image, y is an image label, ∇_{θ} [symbol] _{θ}(x, y) is a loss gradient of the reconstruction image and image label w.r.t. model weights, ∇_{θ} [symbol] _{θ}(x*, y) is a loss gradient of the input image and image label w.r.t. model weights, and α TV(x) is a total variation function of the reconstruction image.

18. The non-transitory storage medium of claim 11, wherein pruning the gradient values that are greater than a p-th percentile from the first loss gradient tensor comprises zeroing out the index positions of gradient values that are greater than a p-th percentile.

19. The non-transitory storage medium of claim 11, wherein a Peak Signal-to-Noise Ratio (PSNR) and a Structural Similarity Index (SSIM) are obtained that are less than a PSNR and SSIM obtained from a random pruning operation and a gradient compression operation.

20. The non-transitory storage medium of claim 11, wherein a lower loss and a higher accuracy are obtained than a loss or accuracy obtained from a random pruning operation and a gradient compression operation.
